(19) United States
(12) Patent Application Publication
(10) Pub. No.: US 2006/0251235 A1
(43) Pub. Date: Nov. 9, 2006

(54) Advanced intelligent network access manager with state machine for processing multiple TCAP component messages

(75) Inventor: Chou-Ling Ting, Plano, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/124,693

(22) Filed: May 9, 2005

(51) Int. Cl. H04M 7/00

(52) U.S. Cl. 379/230

(57) ABSTRACT

A service control function is interfaced to a call segment association in a telecommunications network. TCAP messages are used for communication with the service control function. In correspondence with the processing of information carried in the TCAP messages, a state machine assumes a plurality of states, one of which corresponds exclusively to the processing of component information carried in component portions of the TCAP messages.

### TECHNICAL FIELD OF THE INVENTION

The present invention relates generally to SoftSwitches and, more particularly, to call processing within a SoftSwitch.

### BACKGROUND OF THE INVENTION

SoftSwitch architectures support voice and data telecommunication services. SoftSwitches direct the switching activities of media gateways, which are used to convert voice and signaling from analog technologies such as PSTN and SS7 to IP packets. Although SoftSwitches perform different levels of call processing, their functionality generally relates to call control and routing, signaling intelligence, service creation and enhanced Intelligence Network (IN) services such as 800-number translations.

A central component of the SoftSwitch architecture is the Advanced Intelligent Networks (AIN) access manager. The AIN access manager provides the necessary services to process inbound and outbound AIN and IN1 messages. In doing so, the AIN access manager must maintain the Transaction Capabilities Application Part (TCAP) transaction state information. However, many of the inbound and outbound AIN and IN1 messages may include multiple components. The state machines used in conventional AIN access managers generally comprise an Idle state, a Dialogue Initialized state, a Dialogue Received state, and a Dialogue Active state. These state machines are not optimized for handling the multiple components of the inbound and outbound AIN and IN1 messages and maintaining the correct sequence of messages is complicated.

Therefore, there is a need for an Intelligent Network system that simplifies the processing by the AIN access manager processing of TCAP messages that include many component requests (or indications) in their component layers. In particular, there is a need for an AIN access manger that implements an improved state machine for handling TCAP messages having many component requests (or indications) in their component layers.

### SUMMARY OF THE INVENTION

To address the above-discussed deficiencies of the prior art, it is a primary object of the present invention to provide an AIN Access Manager with a state machine that effects a separation of the processing of the component layer of a TCAP message from the processing of the transaction layer of that message. In an exemplary embodiment, the present invention provides a new state that is dedicated exclusively to processing the component layer of the message.

It is a primary object of the present invention to provide an apparatus for interfacing a service control point to a call segment association that is maintained externally relative to the service control point. According to an advantageous embodiment of the present invention, the apparatus comprises: i) a first communication path which supports communication with the service control point via TCAP messages which each include a transaction portion and a component portion; ii) a second communication path which supports communication with the call segment association; and iii) an access manager coupled between the first and second communication paths for processing information carried in the TCAP messages, the access manager implementing a state machine which assumes a plurality of states associated with the processing of information carried in the TCAP messages, one of the states associated exclusively with processing component information carried in the component portions of the TCAP messages.

According to one embodiment of the present invention, the first communication path supports transmission of TCAP messages to the service control point, wherein the access manager encodes the component information to support production of component requests carried in the component portions of the TCAP messages, and wherein the one state corresponds exclusively to the encoding of the component information.

According to another embodiment of the present invention, one of the component portions includes a plurality of the component requests.

According to still another embodiment of the present invention, one of the transaction portions includes a query request.

According to yet another embodiment of the present invention, one of the transaction portions includes a response request.

According to a further embodiment of the present invention, one of the transaction portions includes a conversation request.

According to a still further embodiment of the present invention, one of the transaction portions includes a query request, one of the transaction portions includes a response request, and one of the transaction portions includes a conversation request.

According to a yet further embodiment of the present invention, wherein the state machine remains in the one state while the access manager encodes all of the component information that is carried in the plurality of component requests.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates the call processing portion of a SoftSwitch architecture according to an exemplary embodiment of the present invention;

FIG. 2 illustrates a portion of FIG. 1 in more detail according to an exemplary embodiment of the present invention;

FIG. 3 illustrates an instance of a CSA in FIG. 2 according to an exemplary embodiment of the present invention;

FIG. 4 illustrates a state diagram implemented by the state machine of FIG. 2 according to an exemplary embodiment of the present invention;

FIG. 5 is a call flow diagram illustrating an outgoing communication supported by the architecture of FIGS. 2 and 4 according to an exemplary embodiment of the present invention; and

FIG. 6 is a call flow diagram illustrating an incoming communication supported by the architecture of FIGS. 2 and 4 according to an exemplary embodiment of the present invention.

### DETAILED DESCRIPTION OF THE INVENTION

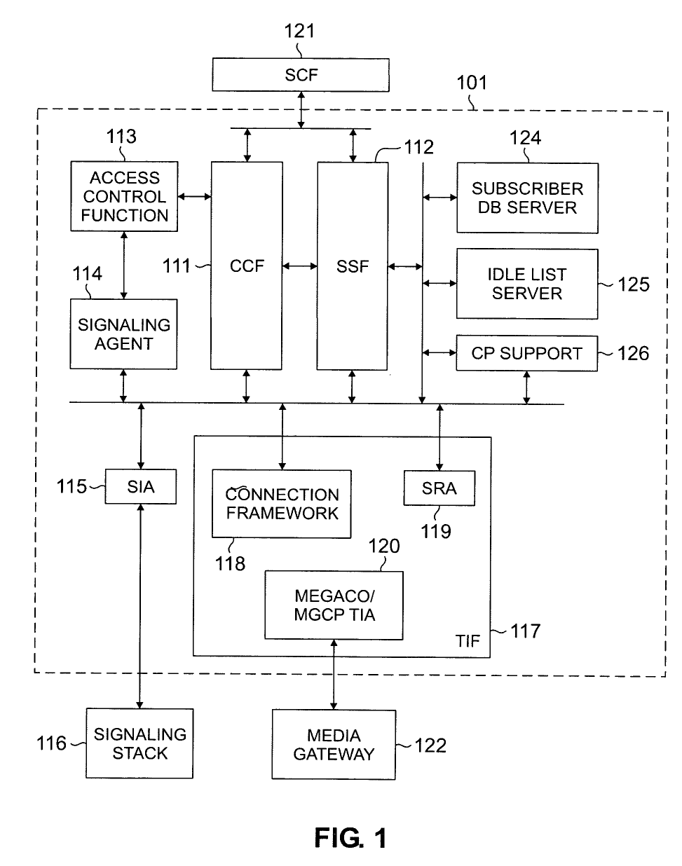

FIGS. 1 through 6, discussed herein, and the various embodiments used to describe the principles of the present invention in this patent document are by way of illustration only and should not be construed in any way to limit the scope of the invention. Those skilled in the art will understand that the principles of the present invention may be implemented in any suitably arranged telecommunications network.

FIG. 1 illustrates pertinent portions of a SoftSwitch architecture according to an exemplary embodiment of the present invention. Dotted outline 101 comprises components of the call processing (CP) portion (also referred to herein as call processing framework) of the SoftSwitch. The call processing framework of FIG. 1 is a Next Generation Network Service (NGNS) call processing framework.

Call control function (CCF) 111 and service switching function (SSF) 112 follow the IN CS-2 call model and provide the main call control and service switching functions. Access control function (ACF) 113 processes access signaling protocol specific control and interactions. ACF 113 handles different access signaling protocols and provides a generic and uniform behavior adaptation towards CCF 111 and service control function (SCF) 121. For each supported signaling protocol (e.g., ISUP), there will be a specific ACF component to handle the unique signaling protocol behavior (e.g., ISUP ACF). SoftSwitch call processing ACF components include ISUP ACF, SIP ACF, H.323 ACF, and POTS (Plan Old Telephone Service) ACF.

Signaling agent (SA) 114 interoperates with ACF 113 to encode and decode signaling protocol specific messages and information elements. SoftSwitch call processing SA components include ISUP SA, SIP SA, H.323 SA, and POTS SA. Signaling interface adapter (SIA) 115 interfaces with the software and hardware of signaling stack 116. SIA 114 separates the signaling stack implementations from the upper layer SA and ACF implementations. SIA 114 allows easy adaptation of different third-party stack packages, as well as external signaling gateways.

TP interface function (TIF) 117 includes connection framework 118, specialized resource agent (SRA) 119, and TP interface adapter (TIA) 120. Connection framework 118 manages connection context and end-point management. Specialized resource agent 119 provides a generic interface to the NGNS CP applications for specialized resource operations (e.g., play tone, receive DTMF digits). TP interface adapter (TIA) 120 translates internal connection and specialized resource related command/report into application programming interfaces (APIS) that are recognized by the Media Gateway 122. SoftSwitch CP supports the MGCP TIA and Megaco APIs shown in FIG. 1.

Subscriber DB server 124 provides a database function for in-switch subscriber profile records. Idle List Server 125 manages circuit idle lists for ISUP circuits. CP support function 126 provides miscellaneous call processing support functions such as audit, debug, and trace functions.

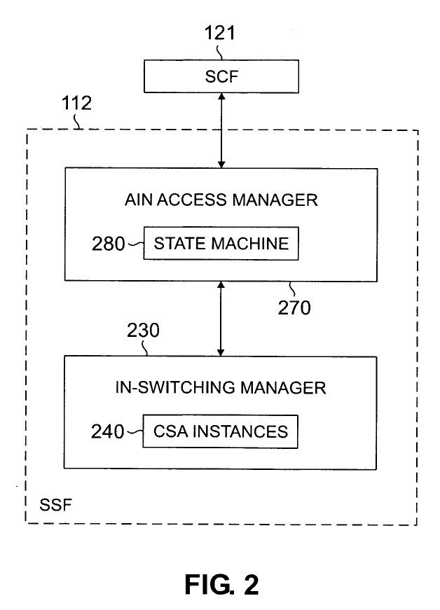

FIG. 2 illustrates portions of SSF 112 in greater detail according to an exemplary embodiment of the present invention. SSF 112 comprises AIN access manager (AINAM) 270 and Intelligent Network-switching manager 230. Intelligent Network-switching manager (IN-SM) 230 interacts with SCF 121 in the course of providing IN service features to users. IN-SM 230 provides SCF 121 (implemented by a service control point) with an interface to the SSF/CCF call connection processing activities and provides SCF 121 with access to SSF/CCF capabilities and resources. IN-SM 230 also detects IN call/connection processing events that should be reported to active IN service logic instances and manages SSF 112 resources required to support IN service logic instances.

IN-SM 230 centers around an IN-switching state model (IN-SSM), which provides a description of the SSF/CCF IN call/connection processing in terms of IN call/connection states. The IN-SSM provides a finite state machine description of SSF/CCF IN call/connection processing in terms of IN call/connection states. The IN-SSM provides a framework for describing the scope of view and control of SSF/CCF activities offered to SCF 121. The extent to which IN-SSM is accessible to SCF 121 is defined by the information flows identified for IN CS2 between the SSF/CCF and the SCF.

IN call/connection states can be described in terms of the IN-switching state model (IN-SSM), which defines the set of SSF/CCF objects accessible to SCF 121. Each IN-SSM instance provides SCF 121 with limited access into SSF/CCF IN call/connection processing. The objects that constitute the IN-SSM define this accessibility. These objects are abstractions of SSF/CCF resources accessible to SCF 121.

Call segment association (CSA) instances 240 are created in IN-SM 230 whenever an incoming call setup request is received. A CSA instance also may be created when initiated by SCF 121, independently of encountering an incoming call setup request. A CSA instance is destroyed when SCF 121 informs SSF 112 that the IN service logic instance is completed or that the CSA should be destroyed. SSF 112 can also initiate CSA destruction.

AIN access manager (AINAM) 270 further comprises state machine 280. AINAM 270 provides a gateway from SSF 112 to SCF 121 for AIN processing. AINAM 270 accepts SSF Event messages from IN-SM 230, converts the Event messages to AIN format, and interacts with the TCAP (Transaction Capabilities Application Part) capabilities to send the messages to SCF 121. In the reverse direction, AINAM 270 receives instructions from SCF 121 and issues commands to the appropriate components for execution. State machine 280 supports these operations performed by AINAM 270.

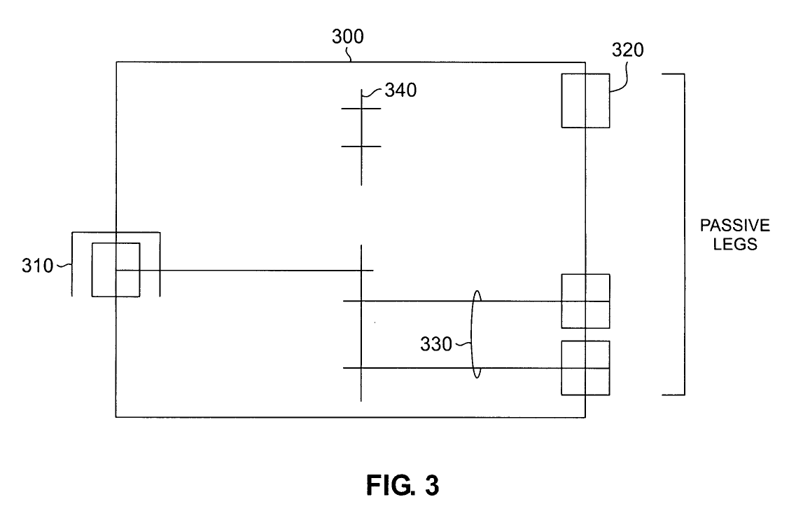

FIG. 3 illustrates an example of call segment association (CSA) instance 300 according to an exemplary embodiment of the present invention. FIG. 3 shows two classes of objects that have been identified: legs and connection points. The leg objects include controlling leg 310, unconnected leg 320, and connected legs 330. A leg is a representation of a communication path towards an addressable network entity, as viewed from CSA instance 300. Exemplary connection point 340 is a representation of the interconnection of legs, as viewed by CSA instance 300, which allows information to flow between legs. The underlying layers that establish communications paths, and maintain connections between them, are the basic call processes modeled by one or more Basic Call State Machines (BCSMs) in CCF 111. As such, the CSA objects reflect both connectivity information (e.g., the relation of legs and connection points to each other) and call processing information (e.g., BCSM events and basic call-related information), which can be used by an instance of IN service logic to influence the connectivity and call processing aspects of a call.

The attributes of the objects and their relation to each other describe the state of the connections, and the supporting basic call processes, represented by CSA instance 300. SCF 121 can invoke functions of SSF 112 that manipulate these objects (e.g., changing their attributes or their relationship to each other, thereby changing the state of the connections and the supporting basic call processes). This state information is provided to SCF 121 via information flows and information elements.

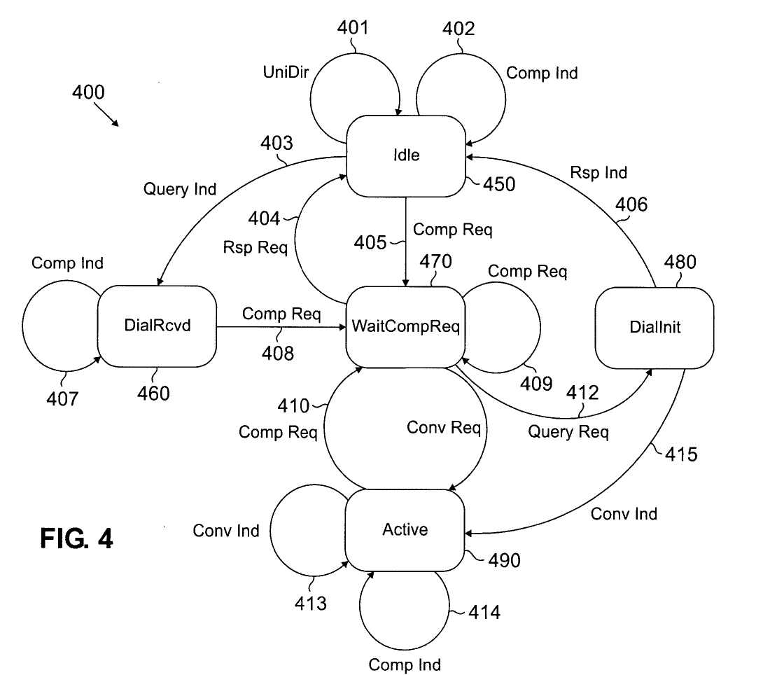

FIG. 4 illustrates state diagram 400, which is implemented by state machine 280 of FIG. 2 according to an exemplary embodiment of the invention. In state diagram 400 of FIG. 4, wait state 470 is provided for processing component request messages in the component layer of the outgoing TCAP request messages. Wait state 470 is specifically denominated “WaitCompReq” in FIG. 4 because state machine 280 of FIG. 2 waits until all of the component requests in the component layer of a TCAP request message have been processed (encoded) before transitioning from wait state 470 to another state of the diagram in FIG. 4.

Assuming for example the situation of an outgoing TCAP query request message, state machine 280 of FIG. 2 would begin from idle state 450 of FIG. 4. In response to the arrival of the component layer information for the TCAP query request message (which arrives before the transaction layer information of the message), state machine 280 follows transition 405 to assume wait state 470. As indicated generally at 409, state machine 280 remains in wait state 470 until all of the information for all of the component requests in the component layer of the TCAP query request message has been received and processed.

As the information for each component request arrives, state transition path 409 is followed so that the component request is processed in wait state 470. After all component requests within the component layer of the TCAP message have been received and processed in wait state 470, state machine 280 then follows transition 412 into DialInit state 480 to process the transaction layer of the outgoing TCAP message, and thereafter to await either a TCAP response indication message or a TCAP conversation indication message from SCF 121. If a TCAP response indication message arrives, the transaction portion thereof is processed in DialInit state 480, after which occurs transition 406 from DialInit state 480 to idle state 450. Thereafter, any component indications within the component layer of the received TCAP response indication message are received and processed in idle state 450, as indicated generally at 402 in FIG. 4.

If a TCAP conversation indication message is received in DialInit state 480, the transaction portion thereof is processed in DialInit state 480, and state machine 280 takes transition 415 into active state 490. In active state 490, any component indications in the component layer of the TCAP conversation indication message are received and processed as illustrated generally at 414. After all of the component indications in the component layer of the received TCAP conversation indication message have been received and processed in active state 490, state machine 280 remains in active state 490 until the component layer of the next TCAP request message arrives. This triggers transition 410 to wait state 470. As before, wait state 470 awaits and encodes all component requests within the component layer of the TCAP request message.

Thereafter, the transaction layer of the TCAP request message arrives. If the transaction layer includes a TCAP response request, then state machine 280 takes transition 404 from wait state 470 into idle state 450 for processing of the response request in the transaction layer of the TCAP request message.

If the transaction layer of the TCAP request message includes a conversation request, then state machine 280 takes transition 411 from wait state 470 to active state 490 for processing the conversation request in the transaction layer of the outgoing TCAP conversation request message. As indicated by the state transitions at 413 and 414, during active state 490, AINAM 270 processes the transaction layer (413) and the component layer (414) of any incoming TCAP conversation indication message. As described above, outgoing TCAP conversation request messages are processed by taking transition 410 from active state 490 to wait state 470, then remaining in the wait state (to process all component requests) by taking one or more transitions 409, and then taking transition 411 to active state 490.

An outgoing TCAP response request message also triggers the transition at 410 from active state 490 to wait state 470, where all component requests within the component layer of the TCAP response request message will be awaited and processed in the same manner described above. When the transaction layer of the TCAP response request message arrives, however, this will trigger transition 404 from wait state 470 to idle state 450, where the transaction layer of the TCAP response request message will be processed.

If the transaction portion of an incoming TCAP query indication message arrives while in idle state 450, this triggers transition 403 from idle state 450 to DialRcvd state 460. The transaction layer of the incoming TCAP query indication message is processed in DialRcvd state 460, as are any and all component indications in the component layer of the incoming TCAP query indication message. This component layer processing is indicated generally by transition 407.

While in DialRcvd state 460, the arrival of a component layer of an outgoing TCAP request message triggers transition 408 from DialRcvd state 460 to wait state 470. As described above, wait state 470 persists until all component requests in the component layer of the outgoing TCAP request message have been processed. Thereafter, the arrival of a response request in the transaction layer of the outgoing TCAP request message triggers transition 404 to idle state 450, whereas the arrival of a conversation request in the transaction layer of the outgoing TCAP request message triggers transition 411 into active state 490. State diagram 400 of FIG. 4 also includes an idle state-to-idle state transition 401 which corresponds to unidirectional TCAP messages.

As is evident from the foregoing description, provision of WaitCompReq state 470 permits simplification of the design, implementation, and operation of DialInit state 480 and active state 490, which are no longer associated with processing the component layers of TCAP request messages. This simplifies the overall design, implementation and operation of AINAM 270.

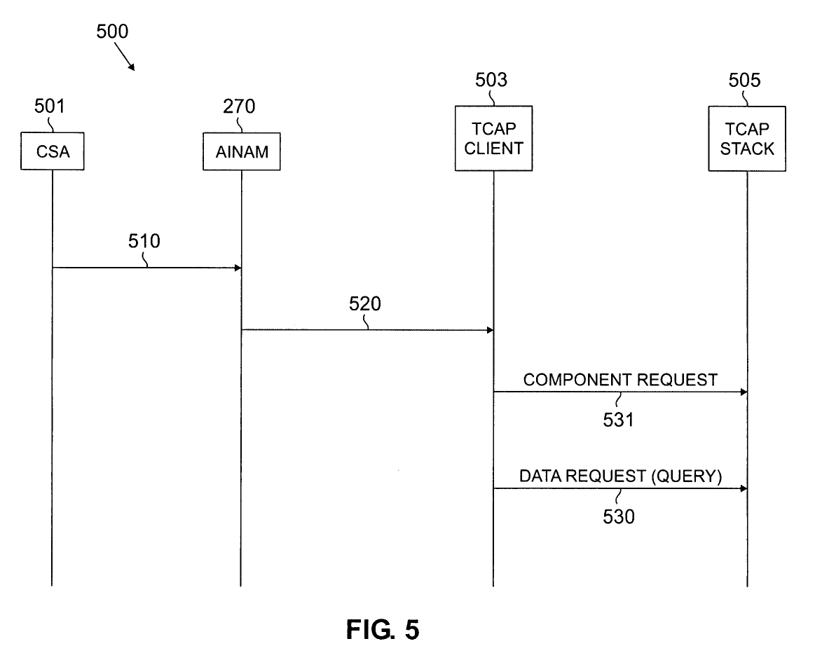

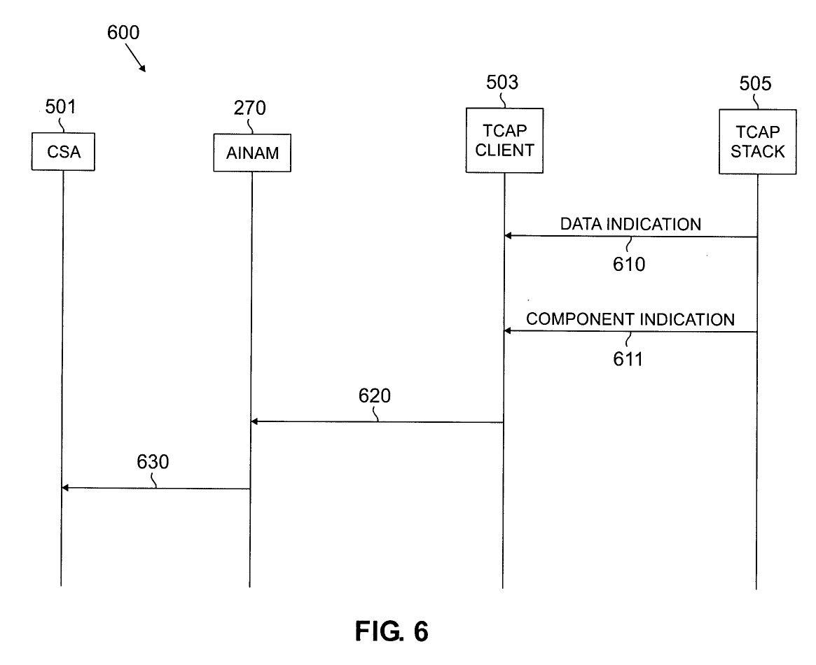

FIGS. 5 and 6 depict call flow diagrams 500 and 600, which illustrate how various objects or modules within the call processing portion (also referred to as the call processing program or call processing module) of FIG. 1 cooperate to effectuate communications between IN switching manager 230 and SCF 121. The communications carried out in flow diagrams 500 and 600 may be implemented using state diagram 400 described above in FIG. 4.

FIG. 5 illustrates an outgoing communication from CSA instance 501 within IN switching manager 230 to SCF 121 according to an exemplary embodiment of the present invention. The FIG. 5 communication is a query request that is utilized when a service (e.g., Local Number Portability) supported by the call processing portion needs to initiate a new transaction to SCF 121.

CSA instance 501 generates and transmits generic request message 510 to AINAM 270. AINAM 270 encodes the operation parameters and constructs interface generic message 520. AINAM 270 then sends interface generic message 520 to TCAP client 503 (provided in SSF 112). TCAP client 503 interfaces between AINAM 270 and TCAP stack 505 (provided in SSF 112). TCAP client 503 and TCAP stack 505 are thus provided in a communication path between AINAM 270 and SCF 121. TCAP client 503 uses an API function to encode interface generic message 520 into a two-layer TCAP message, which includes transaction portion (or layer) 530 and component portion (or layer) 531. Component portion 531 precedes the transaction portion 530 in outgoing TCAP communications such as the outgoing query request of FIG. 5. Outgoing TCAP communications, and the messages contained in the two constituent layers thereof, are also referred to herein generally as requests.

FIG. 6 illustrates an incoming communication from SCF 121 to CSA instance 501 according to an exemplary embodiment of the present invention. Incoming TCAP communications, and the messages contained in the two constituent layers thereof, are also referred to herein generally as indications. By way of example, the incoming communication of FIG. 6 could be a response indication produced by SCF 121 as a reply to the query request of FIG. 5. As another example, the incoming communication of FIG. 6 could be a query indication initiated unilaterally by SCF 121.

The incoming TCAP communication is a two-layer message including transaction portion 610 and component portion 611. In an incoming TCAP message, transaction portion 610 precedes component portion 611, as illustrated in FIG. 6. The two-layer TCAP message 610, 611 is delivered to TCAP client 503, which decodes TCAP message 610, 611 to form interface generic message 620. Interface generic message 620 is forwarded to AINAM 270 for further decoding. AINAM 270 decodes interface generic message 620 and constructs generic message 630. Generic message 630 is then forwarded to CSA instance 501.

Although only one component indication is illustrated in component layer 611 of the TCAP indication message in FIG. 6, component layer 611 may include a plurality of component indications. Similarly, component layer 531 of the TCAP request message of FIG. 5 also may include a plurality of component requests. A TCAP message that includes many component requests or indications in its component layer requires more extensive processing in AINAM 270 than does a TCAP message with only one or a few component requests/indications in its component layer. This can complicate the design, implementation and operation of AINAM 270.

Although the present invention has been described with an exemplary embodiment, various changes and modifications may be suggested to one skilled in the art. It is intended that the present invention encompass such changes and modifications as fall within the scope of the appended claims.

What is claimed is:

1. An apparatus for interfacing a service control point to a call segment association that is maintained externally relative to the service control point, comprising:
a first communication path which supports communication with the service control point via TCAP messages which each include a transaction portion and a component portion;
a second communication path which supports communication with the call segment association; and
an access manager coupled between said first and second communication paths for processing information carried in the TCAP messages, said access manager implementing a state machine which assumes a plurality of states associated with said processing of information carried in the TCAP messages, one of said states associated exclusively with processing component information carried in the component portions of the TCAP messages.

2. The apparatus as set forth in claim 1, wherein said first communication path supports transmission of TCAP messages to the service control point, wherein said access manager encodes said component information to support production of component requests carried in the component portions of the TCAP messages, and wherein said one state corresponds exclusively to said encoding of said component information.

3. The apparatus as set forth in claim 2, wherein one of said component portions includes a plurality of said component requests.

4. The apparatus as set forth in claim 3, wherein one of said transaction portions includes a query request.

5. The apparatus as set forth in claim 3, wherein one of said transaction portions includes a response request.

6. The apparatus as set forth in claim 3, wherein one of said transaction portions includes a conversation request.

7. The apparatus as set forth in claim 3, wherein one of said transaction portions includes a query request, one of said transaction portions includes a response request, and one of said transaction portions includes a conversation request.

8. The apparatus as set forth in claim 3, wherein said state machine remains in said one state while said access manager encodes all of said component information that is carried in said plurality of component requests.

9. A telecommunications network, comprising:
a service control point; and
an interface apparatus coupled to said service control point for interfacing said service control point to a call segment association that is maintained externally relative to said service control point, said interface apparatus including a first communication path which supports communication with the service control point via TCAP messages which each include a transaction portion and a component portion, a second communication path which supports communication with the call segment association, and an access manager coupled between said first and second communication paths for processing information carried in the TCAP messages, said access manager implementing a state machine which assumes a plurality of states associated with said processing of information carried in the TCAP messages, one of said states associated exclusively with processing component information carried in the component portions of the TCAP messages.

10. The telecommunications network as set forth in claim 9, wherein said first communication path supports transmission of TCAP messages to said service control point, wherein said access manager encodes said component information to support production of component requests carried in the component portions of the TCAP messages, and wherein said one state corresponds exclusively to said encoding of said component information.

11. The telecommunications network as set forth in claim 10, wherein one of said component portions includes a plurality of said component requests.

12. The telecommunications network as set forth in claim 11, wherein one of said transaction portions includes a query request.

13. The telecommunications network as set forth in claim 11, wherein one of said transaction portions includes a response request.

14. The telecommunications network as set forth in claim 11, wherein one of said transaction portions includes a conversation request.

15. The telecommunications network as set forth in claim 11, wherein one of said transaction portions includes a query request, one of said transaction portions includes a response request, and one of said transaction portions includes a conversation request.

16. The telecommunications network as set forth in claim 11, wherein said state machine remains in said one state while said access manager encodes all of said component information that is carried in said plurality of component requests.

17. A method of interfacing a service control function to a call segment association, comprising:
communicating with the service control function via TCAP messages which each include a transaction portion and a component portion; and
processing information carried in the TCAP messages, including assuming a plurality of states of a state machine, wherein one of said states is associated exclusively with processing component information carried in the component portions of the TCAP messages.

18. The method as set forth in claim 17, wherein said communicating step includes transmitting the TCAP messages to the service control function, said processing step including encoding said component information to support production of component requests carried in the component portions of the TCAP messages, and said assuming step including assuming said one state exclusively in correspondence to said encoding of said component information.

19. The method as set forth in claim 18, wherein one of said component portions includes a plurality of said component requests.

20. The method as set forth in claim 19, including remaining in said one state while encoding all of said component information that is carried in said plurality of component requests.
